(19) United States
(12) Patent Application Publication
(10) Pub. No.: US 2014/0083174 A1
(43) Pub. Date: Mar. 27, 2014

(54) SAMPLE NEBULIZATION

(71) Applicants: Julien Reboud, Glasgow (GB); Robert Wilson, Glasgow (GB); Jonathan Cooper, Glasgow (GB)

(72) Inventors: Julien Reboud, Glasgow (GB); Robert Wilson, Glasgow (GB); Jonathan Cooper, Glasgow (GB)

(21) Appl. No.: 14/117,822

(22) PCT Filed: May 18, 2012
(86) PCT No.: PCT/GB2012/051133

§ 371 Date: Dec. 10, 2013

(30) Foreign Application Priority Data
May 19, 2011 (GB) 1108462.1

(51) Int. Cl. G01N 1/28; B05B 17/06

(52) U.S. Cl. CPC G01N 1/28; B05B 17/0653
USPC 73/61.59; 239/102.2; 250/281

(57) ABSTRACT

A device for generating a nebulized sample for detection of an analyte. The device includes a surface acoustic wave (SAW) transducer and a superstrate. The superstrate has a first surface for coupling with the SAW transducer and a second surface for receiving a fluid sample incorporating the analyte. The fluid sample is nebulized from the second surface. The superstrate is provided with an electrical connection extending from the second surface of the superstrate to provide a conducting path from a charge source to the second surface of the superstrate. The charge source may be the surface of the transducer or an external voltage source.

### BACKGROUND TO THE INVENTION

1. Field of the Invention

The present invention relates to the generation of a nebulized plume of a sample for subsequent analysis. Of particular, but not necessarily exclusive, interest is the generation of a nebulized sample for analysis using a mass spectrometer.

2. Related Art

Mass spectrometry is a useful tool for the identification and analysis of biomolecules such as proteins.

There are various techniques known to assist in the preparation of biomolecules for analysis by mass spectrometry in the field of proteomics. Two of the most important of these techniques are MALDI (matrix-assisted laser desorption/ionization) and ESI (electrospray ionization).

In the MALDI technique, the biomolecules of interest are held in a solution of known matrix molecules, typically acidic with strong absorption in the UV or IR range. The solvent is allowed to evaporate, leaving a solid composite, consisting of matrix holding the biomolecules of interest. The composite is then irradiated with a laser. This has the effect of generating ions from the composite, which can subsequently be sampled by a mass spectrometer. MADLI is referred to as a soft ionization technique, because the ionization process, due to the effect of the matrix molecules, tends to protect the biomolecules from degradation.

MALDI generates primarily [M+H]⁺ ions. Whereas ESI generates ions continuously, MALDI is a pulsed technique allowing separation to be decoupled from ionization. This decoupling provides the opportunity to re-examine a sample repeatedly.

However, MALDI provides ions that are contaminated with matrix molecules at low mass to charge ratio (m/z) and the concentration of the species of interest can typically be relatively low. Furthermore, MALDI typically cannot provide multiple charged precursor ions.

In the ESI technique, a liquid containing the biomolecule of interest is dispersed into a fine aerosol using an electrospray device. In the electrospray device, the liquid is emitted through a capillary. High voltage is applied to the liquid, leading to the formation of small charged droplets which are dispersed due to Coulomb repulsion. The solvent is removed by evaporation in this process

For over a decade, ESI has been one of the most popular methods for transferring nonvolatile compounds, including peptides, to the gas phase, typically coupling real-time separations (e.g., high-pressure liquid chromatography (HPLC)) to mass spectrometry detection. Apart from generation of a continuous stream of ions for HPLC-MS operation, one of the main advantages of ESI is that multiple charged precursor ions result. These higher order charge states, i.e., [M+nH]ⁿ⁺ where n>1, produce peptide tandem mass spectra to which a sequence is easily assigned.

In ESI, particularly at low flow rates, the capillary needs to be very fine. However, this can cause practical problems of clogging of the capillary. Furthermore, the use of a high voltage electrode in contact with the sample can cause unwanted electrochemical oxidation.

ESI and MALDI have transformed mass spectrometry research of nonvolatile biologics and have now largely replaced all prior ionization methods, due to their facile implementation and “soft” transfer processes. They do both however have analytical short-comings that have led to continued research to improve them; i.e., to be more efficient or “softer” (with less perturbation of the analyte). This applies particularly to ESI, in which a relatively high energy ionization process is used and this can lead to unwanted degradation of the species of interest.

Recently, a new proposal has been made for the transfer of nonvolatile analytes to the gas phase using surface acoustic wave nebulization. See Heron et al (2010) [Scott R. Heron, Rab Wilson, Scott A. Shaffer, David R. Goodlett, Jonathan M. Cooper “Surface Acoustic Wave Nebulization of Peptides As a Microfluidic Interface for Mass Spectrometry” Anal. Chem. 2010, 82, 3985-3989].

Heron et al (2010) disclose the fabrication of a surface acoustic wave (SAW) device on a LiNbO₃ piezoelectric transducer for the transfer of nonvolatile analytes to the gas phase at atmospheric pressure (a process referred to as nebulization or atomization). It is shown how such a device can be used in the field of mass spectrometry (MS) detection, demonstrating that SAW nebulization (SAWN) can be performed either in a discontinuous or pulsed mode, similar to that for MALDI or in a continuous mode like ESI.

Ho et al (2011) [Ho J, Tan M K, Go D B, Yeo L Y, Friend J R, and Chang H C “Paper-based microfluidic surface acoustic wave sample delivery and ionization source for rapid and sensitive ambient mass spectrometry” Anal. Chem. 2011 May 1; 83(9):3260-6] also disclose the generation of nebulized samples for mass spectrometry. Ho et al (2011) sets out a proposed mechanism for charge transfer from the surface of the piezoelectric wafer to the fluid sample during nebulization, the content of which is hereby incorporated by reference, without wishing any aspect of the present invention to be limited by the proposed theory. The sample is first held by capillary forces in a piece of filter paper. The loaded filter paper is placed on the piezoelectric wafer and the SAWs act to draw the fluid sample from the paper onto the surface of the piezoelectric wafer, and the sample is subsequently nebulized from the surface of the piezoelectric wafer.

### SUMMARY OF THE INVENTION

The present invention is based on a development from the work reported by Heron et al (2010). The entire content of Heron et al (2010) is hereby incorporated by reference.

The SAW devices used by Heron et al (2010) were manufactured from a 128° Y-cut X-propagating 3 inch LiNbO₃ wafer that was diced into four segments of equal size, each with a 1.5 inch front edge. Each device was made up of 10 pairs of 100 μm interdigitated (IDT) electrodes (20 in total) with a 200 μm spacing and a 10 mm aperture. The SAW transducer was created using photolithography and lift-off on the piezoelectric substrate. The samples of protein solution were placed dropwise onto the aperture of each device, and the device operated to generate a nebulized plume for sampling with a mass spectrometer.

As will be understood from the above explanation, each device was used only for one protein solution sample. In order to re-use the device for a different protein solution sample, given the high sensitivity of mass spectrometry, it would be necessary to very carefully clean the device. Such an approach is impractical, since it depends heavily on the cleaning process being reproducible and thorough, which can be difficult in a laboratory environment. However, an alternative is to use each device only once. This is a very inefficient solution, in terms of cost.

Therefore it would be much preferred to be able to use the SAW transducer in combination with a disposable superstrate, in order that the SAW transducer can be kept out of direct contact with the biological analyte, and can therefore be re-used. An arrangement of a SAW transducer and a disposable superstrate is disclosed in WO 2011/023949, the content of which is incorporated by reference in its entirety. WO 2011/023949 discloses the efficient coupling and, in some cases, controlled distribution of SAWs from the transducer to the surface of the superstrate by a suitable array of SAW scattering elements at the superstrate surface. Coupling is achieved using a thin film of a suitable coupling liquid between the transducer surface and the superstrate. The superstrate is typically moulded from plastics material.

However, in order for the nebulized plume to be useful, the droplets must be charged, so that they can be handled satisfactorily by the mass spectrometer. When a sample is nebulized directly from the SAW transducer surface, the nebulized plume is satisfactorily charged. The present inventors speculate, without wishing to be limited by theory, that the charge comes from the SAW wave on the piezoelectric crystal, and that this is transferred to the liquid when the liquid is placed directly on the piezoelectric crystal.

The present inventors have found that when the sample is instead placed on a disposable superstrate, the nebulized plume is difficult to handle. The present inventors consider that this is due to a difficulty in charging the droplets. The present invention is based on the identification of this technical problem.

The present invention has been devised in order to address at least one of the above problems. Preferably, the present invention reduces, ameliorates, avoids or overcomes at least one of the above problems.

Accordingly, in a first preferred aspect, the present invention provides a device for generating a nebulized sample for detection of an analyte, the device including a SAW transducer and a superstrate, the superstrate having a first surface for coupling with the SAW transducer and a second surface for receiving a fluid sample incorporating the analyte and for nebulizing the fluid sample from the second surface, wherein the superstrate is provided with an electrical connection extending from the second surface of the superstrate to provide a conducting path from a charge source to the second surface of the superstrate.

In a second preferred aspect, the present invention provides a method for analysis of an analyte, including the steps of:
providing a fluid sample incorporating the analyte;
providing a SAW transducer;
providing a superstrate having a first surface and a second surface;
providing an analytical instrument having an inlet port for receiving analyte;
coupling the first surface of the superstrate to the SAW transducer so as to transmit SAWs from the SAW transducer to the second surface of the superstrate;
locating the fluid sample on the second surface of the superstrate; and
operating the SAW transducer to nebulize the sample from the second surface of the superstrate to cause at least some of the nebulized sample to enter the inlet port of the analytical instrument whilst providing a conducting path from the second surface of the superstrate to a charge source.

In a third preferred aspect, the present invention provides a system for analysis of an analyte, the system having:
a SAW transducer;
a superstrate; and
an analytical instrument having an inlet port for receiving analyte,
   wherein the superstrate has a first surface for coupling with the SAW transducer and a second surface for receiving a fluid sample incorporating the analyte, and wherein the superstrate is provided with an electrical connection extending from the second surface of the superstrate to provide a conducting path from a charge source to the second surface of the superstrate, the SAW transducer being operable to nebulize the sample from the second surface of the superstrate to cause at least some of the nebulized sample to enter the inlet port of the analytical instrument for analysis.

The first, second and/or third aspect of the invention may have any one or, to the extent that they are compatible, any combination of the following optional features.

It is considered by the inventors (without wishing to be limited by theory) that SAWs tend to at least partially refract into the fluid sample. This refraction is due to the fluid sample having, in general, a different speed of propagation for the SAWs compared with the substrate. This produces streaming in the fluid sample. Accordingly, this is considered to be the origin of sample manipulation (including movement and nebulization) under the influence of SAWs.

It is possible that the fluid sample is in the form of a drop, e.g. a droplet such as a microfluidic droplet. However, other arrangements are possible for the fluid sample, e.g. a channel of fluid, or a fluid held in a chamber. In the following discussion, the term “droplet” is used, but as discussed above, it is intended that the invention is not necessarily limited to the manipulation of droplets.

The fluid may comprise a liquid. Furthermore, the fluid may comprise one or more particles. For example, the fluid may be a liquid containing solid (or substantially solid) particles. Of particular interest are fluids comprising a suspension of solid particles in a carrier liquid. The particles of particular interest in the present invention are biomolecules such as peptides and/or proteins.

The volume of the fluid sample depends on the various factors, including the amount of analyte available. In general, it is preferred to use a small volume of sample in order that the sample can contain a relatively high concentration of analyte, but without using a large amount of analyte. For example, the volume of the fluid sample may be at least 1 picolitre. More preferably, the volume of the fluid sample is at least 10 picolitre, at least 100 picolitre or at least 500 picolitre. Larger volumes are contemplated, e.g. at least 1 nanolitre, at least 10 nanolitre, at least 100 nanolitre or at least 500 nanolitre. Still larger volumes are possible in some applications, e.g. at least 1 microlitre or at least 10 microlitre. The preferred upper limit for the volume of the fluid sample is about 5 millilitre, more preferably about 1 millilitre, still more preferably about 0.1 millilitre.

The SAW transducer may be formed from any suitable material for generating surface acoustic waves. SAWs may be generated, for example, by a piezoelectric process, by a magnetostrictive process, by an electrostrictive process, by a ferroelectric process, by a pyroelectric process, by a heating process (e.g. using pulsed laser heating) or by an electromagnetic process. It is most preferred that the SAW generation material layer is formed from a piezoelectric layer. In the disclosure set out below, the term “piezoelectric layer” is used but is it understood here that similar considerations would apply to SAW generation material layers formed, for example, of magnetostrictive materials. Therefore, unless the context demands otherwise, the optional features set out in relation to the “piezoelectric layer” are to be understood as applying more generally to the SAW generation material layer, when formed of any suitable material.

The present inventors further consider that the present invention is not necessarily limited to the use of SAWs. It is considered that sample manipulation using other acoustic waves, such as bulk acoustic waves, is possible using the principles of the present invention. Such acoustic waves are susceptible of manipulation in a similar manner to SAWs. Bulk acoustic waves, for example, give rise to corresponding acoustic waves or displacements at a free surface. Therefore, in the present disclosure, it is to be understood that SAWs are only one example of a suitable acoustic wave which can be used to provide suitable manipulation of a sample. Thus, although in this disclosure the terms “SAW”, “surface acoustic wave”, “SAWs” and “surface acoustic waves” are used, it is to be understood that these may be substituted or supplemented by the terms “bulk acoustic wave” and “bulk acoustic waves” or the terms “acoustic wave” and “acoustic waves”, unless the context demands otherwise.

The present invention is not necessarily limited to any particular orientation. The term “superstrate” is used because in typical implementations of embodiments of the invention, this item is placed on top of the transducer. However, other orientations are contemplated, e.g. in which a corresponding substrate is placed under the transducer, yet the same effect of the invention is seen, in which the sample is nebulized from the surface of the substrate. Furthermore, the present invention is not necessarily limited to a planar configuration. For example, the transducer may be formed inside the superstrate, e.g. in a tubular configuration. Alternatively, the transducer may be formed around the superstrate, with the superstrate in the form of a tube (or hollow needle) held inside a transducer tube. This may be preferred, in order that a continuous (or quasi continuous) supply of sample fluid may be provided to the superstrate tube, with the nebulized plume provided at a free end of the superstrate tube.

Preferably, the superstrate is formed of a material which is impervious to the fluid sample. Thus, it is preferred that the fluid sample sits on top of the second surface of the superstrate without being absorbed into the superstrate to any substantial degree. This helps to avoid any (potentially contaminating) contact between the piezoelectric transducer and the fluid sample. It is noted, in passing, that Ho et al (2011) use a fluid sample loaded in a filter paper, the sample being transmitted to the surface of the piezoelectric wafer under action of the SAWs and subsequently nebulized from the surface of the piezoelectric wafer, which means that the surface of the piezoelectric wafer must be carefully cleaned (i.e. decontaminated) between each experiment if the piezoelectric wafer is to be re-used.

The charge source may be a terminal held at a required electrical potential. For example, the terminal may be the terminal of a suitable power source, typically a DC power source. Thus, the electrical connection may provide the surface of the superstrate with a suitable charge to impart to the nebulizing sample.

However, preferably, the charge source is the surface of the SAW transducer. Suitable transducer materials can be operated in order to provide a suitable charged surface. This is explained in more detail above and below.

Preferably, the electrical connection from the second surface to the charge source is provided at least in part by a solid electrical connection. This may be, for example, in the form of at least one solid film of electrically conducting material. A suitable electrically conducting material may be a metal with low chemical activity and high conductivity, e.g. gold. For convenience, the electrical connection may be provided integrally with the superstrate.

More generally, it is preferred that the electrical connection from the second surface to the charge source is provided by a solid metal electrical connection. It is considered by the inventors that typical semiconductor materials (e.g. silicon or boron-doped silicon) have a resistivity which is too high to provide a suitably low resistance electrical connection to transfer a suitable charge from the charge source to the second surface of the superstrate during operation of the device.

The electrical connection may be provided by a via through the superstrate. Alternatively, the electrical connection may be provided by a conductive track extending around the superstrate.

Where the electrical connection is to be made from the second surface of the superstrate to the surface of the SAW transducer, it is possible for the electrical connection to be mechanically attached to the surface of the SAW transducer. However, this is not preferred, because such a connection may dampen the available SAWs.

In some embodiments, it is convenient for the entire superstrate to be formed of an electrically conductive material. For example, the superstrate may be formed from a suitable metal.

The superstrate may include at least one SAW scattering element. This is preferably operable to affect the transmission, distribution and/or behaviour of SAWs at the superstrate surface.

In some embodiments, the at least one SAW scattering element includes a step change in the height of the second surface of the superstrate. The SAW scattering element may include a ridge. The SAW scattering element may include a groove. More generally, the at least one SAW scattering element may include a linearly extending change in the profile of the second surface of the superstrate.

Preferably, a plurality of SAW scattering elements are provided. These preferably cooperate to provide the required effect on the transmission, distribution and/or behaviour of SAWs at the second surface of the superstrate.

Preferably, the SAW scattering elements have an arrangement based on a periodic arrangement. The periodic arrangement may be a one dimensional arrangement or a two dimensional arrangement. A two dimensional arrangement is preferred. The periodic nature may be, for example, translational symmetry and/or rotational symmetry. The term “based on” is used here because it is considered that the arrangement need not be precisely periodic. Furthermore, the arrangement may be deliberately displaced from a true periodic arrangement in order to provide a specific effect on the surface acoustic waves. For example, the arrangement may be progressively displaced from a true periodic arrangement with distance from a certain starting point in the arrangement. Furthermore, the arrangement may include one or more areas or lines of defective periodicity in the periodic arrangement. In some cases, the periodicity can be varied amid a single crystal by use of gradients, over which the pitch and or the size of the elements is varied. This variation in periodicity can have applications in waveguiding or lenses (focusing the acoustic power).

Typically, the periodic arrangement is a two-dimensional pattern, in that the periodicity extends in two dimensions. Suitable periodic patterns include translationally symmetrical lattice patterns such as tetragonal, square, trigonal, hexagonal, etc. Other suitable periodic patterns include rotationally symmetrical patterns, e.g. having a rotational symmetry of less than 360 degrees.

The SAW scattering elements may be elements that provide an interface capable of significant scattering of SAWs. Preferably, at the interface, there is a sharp change in elastic modulus (e.g. Young's modulus) “seen” by the SAWs. This can be achieved by forming each scattering element from a different material compared with the material of the superstrate, the different material typically having a different density compared with the material of the superstrate. For example, one or more of the scattering elements may be formed by a void at the second surface of the superstrate. The void may be gas-filled, e.g. air-filled. Alternatively, the void may be filled with a different solid or liquid material compared with the material of the remainder of the superstrate. Filling the void with a contrasting (e.g. mechanically, structurally or functionally contrasting) solid material is desirable, because it allows the superstrate to be formed with a smooth second surface, therefore allowing the droplet to move across the arrangement of scattering elements if required. The contrast in mechanical properties between the superstrate and the scattering elements may be changed in use, e.g. by the application of an external stimulus such as heat.

The scattering elements preferably intersect the second surface of the superstrate. This is preferred since they are for scattering surface acoustic waves, which are predominantly surface phenomena. However, the scattering elements may extend to a non-zero depth in the superstrate. For example, they may extend at least 5% into the thickness of the superstrate. They may extend further than this, e.g. at least 10%, at least 20% or more into the thickness of the superstrate. In some circumstances, the scattering elements may extend through the entire thickness of the superstrate, although a depth of about half of the thickness of the superstrate is advantageous. The scattering elements may be pits in the superstrate. Alternatively, the scattering elements may be pillars upstanding from the second surface of the superstrate.

Typically, the scattering elements are cylindrical (e.g. circular or oval cylindrical) in shape, or they may be prismatic or polygonal in shape. Alternatively, the scattering elements may be ridges or grooves. Such shapes may have a straight form, but may alternatively have a curved or angled form. As discussed above, a scattering element may take the form of a step in the surface.

The arrangement of the SAW scattering elements preferably provides, in effect, a phononic crystal structure that interacts with or affects the acoustic field at the second surface of the superstrate. The scattering elements may provide various effects on the SAWs. In addition to the concentration effect mentioned above, the scattering elements may reflect (or partially reflect) the SAWs, and/or may diffract (or partially diffract) the SAWs, and/or may refract (or partially refract) the SAWs. Additionally or alternatively, there may be set up standing interference patterns of SAWs at the substrate surface. For example, the scattering element arrangement preferably effectively concentrates the SAWs in one region. This can provide more efficient nebulization of the sample.

The scattering elements may have an element-to-element nearest neighbour spacing of at least 10 μm. This is suitable for SAWs in the MHz region (e.g. of frequency of around 100 MHz). More preferably, this spacing is at least 20 μm, at least 40 μm, at least 60 μm, at least 80 μm, or at least 100 μm. This spacing may be at most 5 mm (corresponding to relatively low frequency SAWs), more preferably at most 4 mm, more preferably at most 3 mm, more preferably at most 2 mm, more preferably at most 1 mm, more preferably at most 0.9 mm, at most 0.8 mm, at most 0.7 mm, at most 0.6 mm. For example, an element-to-element nearest neighbour spacing in the range 200-500 μm has been shown to be suitable. For higher frequencies, e.g. in the GHz range, smaller spacings are contemplated, e.g. in the range down to at least 1 μm.

In addition to nebulization of the sample, other manipulation of the sample may be carried out (typically prior to nebulization). For example, such other manipulation includes one or more of: movement of the sample; splitting of the sample; combining two or more samples; heating of the sample; concentration of species in the sample; mixing of the sample; sorting fluid samples; sorting particles or cells within fluid samples.

The operation of the apparatus may furthermore allow concentration of the analyte. This can be achieved, for example, by allowing the SAWs to interact with the droplet to heat the droplet, thereby accelerating the evaporation of solvent. Alternatively, the acoustic field may be controlled by an appropriate arrangement of scattering elements and suitable control of the driving signal to the transducer(s) to drive the analyte preferentially towards one part of the droplet. For example, an acoustic cavity can be set up in order to provide a standing wave arrangement, which has been shown to provide particle concentration [Shi, J. et al., 2008. Focusing microparticles in a microfluidic channel with standing surface acoustic waves (SSAW). Lab on a Chip, 8(2), 221-223].

The operation of the apparatus may also allow concentration of a species in one or more droplets by inducing streaming within the droplet, which streaming concentrates species at a location within the droplet. In the context of the present invention, this type of concentration may be referred to as “centrifugation” (even though it may not represent true centrifugation) since it produces a “pellet”-like deposit of species within the “supernatant” of the liquid droplet, and can separate particles in the fluid sample from the fluid phase. This concentration can be achieved by providing SAWs to the droplet to induce rotational streaming in the droplet, for example by providing SAWs to the droplet asymmetrically (i.e. such that the distribution of SAWs is asymmetric with respect to the centre of the droplet footprint). Preferably, the surface of the superstrate includes an arrangement of SAW scattering elements arranged to scatter SAWs into a configuration for inducing rotational streaming in the droplet. The droplet may be positioned on the superstrate at a position relative to the SAW scattering elements such that SAWs are partially scattered by the scattering elements and the droplet receives SAWs distributed asymmetrically with respect to the centre of the droplet footprint.

Preferably, the transducer comprises a layer of piezoelectric material. For example, the layer of piezoelectric material may be a sheet (e.g. a self-supporting sheet) of piezoelectric material. The layer of piezoelectric material may be a single crystal, such as a single crystal wafer. A suitable material is LiNbO₃. A preferred orientation for the cut for this material is Y-cut rot. 128°. This has a higher electromechanical coupling coefficient than other orientations. Other ferroelectric materials may be used, e.g. PZT, BaTiO₃, SbTiO₃ or ZnO. Still further, materials such as SiO₂ (quartz), AlN, LiTaO₃, Al₂O₃ GaAs, SiC or polyvinylidene fluoride (PVDF) may be used. As an alternative to a single crystal, the material can be provided in polycrystalline or even amorphous form, e.g. in the form of a layer, plate or film.

The transducer preferably further comprises at least one arrangement of electrodes. For example, the electrodes may be interdigitated. More preferably, the transducer comprises two or more arrangements of electrodes. These may be disposed in order to provide the specific manipulation desired for the microfluidics droplets, although the arrangement of scattering elements significantly affects the distribution of the acoustic field at the superstrate surface. Suitable arrangements are discussed below. In some embodiments, it is preferred that the transducer is tunable, such that the lateral position of the SAWs emission train is movable. For example, the slanted interdigitated arrangement of electrodes suggested by Wu and Chang [Wu, T. & Chang, I., 2005. Actuating and detecting of microdroplet using slanted finger interdigital transducers. Journal of Applied Physics, 98(2), 024903-7] can be used for the transducer. Slanted interdigitated arrangements of electrodes suitable for use in the present invention are described in more detail below.

Coupling between the transducer and the superstrate may be achieved using a coupling medium, preferably a fluid or gel coupling medium. The coupling medium may be an aqueous coupling medium, e.g. water. Alternatively, the coupling medium may be an organic coupling medium, such as an oil-based coupling medium or glycerol. The coupling medium provides intimate contact between the superstrate and the transducer and allows the efficient transfer of acoustic energy to the superstrate from the transducer. Preferably, the coupling medium is conductive. This allows the device to be operated relying on the coupling medium to provide part of the conductive path from the piezoelectric surface to the superstrate.

The advantage of providing the superstrate as a separate entity from the transducer is very significant. Typical SAW transducers are complex to manufacture. For this reason, they are typically expensive. Analyte contamination of the transducer may be difficult or impossible to remove, if the analyte is allowed to come into contact with the transducer. Alternatively, removal may not be cost-effective, or may damage the transducer. However, it is strongly preferred that the transducer can be re-used. Accordingly, it is preferred that the microfluidic droplet does not contact the transducer but instead contacts the superstrate coupled to the transducer. The superstrate itself may be disposable (e.g. disposed of after a single use). The superstrate may be formed by various methods, such as microfabrication, embossing, moulding, spraying, lithographic techniques (e.g. photolithography), etc.

Preferably, the second surface of the superstrate is substantially planar, optionally excluding the scattering elements. The first surface of the superstrate need not be planar, and in some circumstances may be formed with a topography that provides additional engineering of the SAWs. For example, the first surface may include curved, projecting or recessed regions in order to direct the SAWs.

Preferably, the analytical instrument is a mass spectrometer.

Further optional features of the invention are set out below.

### BRIEF DESCRIPTION OF THE DRAWINGS

Embodiments of the invention will now be described by way of example with reference to the accompanying drawings:

FIG. 1 shows a schematic plan view of a superstrate design for use with the present invention, showing a “funnel” type sample manipulation zone.

FIG. 2 shows a schematic plan view of another superstrate design for use with the present invention, showing a “waveguide” type sample manipulation zone.

FIG. 3 shows a schematic plan view of another superstrate design for use with the present invention, showing a “combination” type sample manipulation zone.

FIGS. 4 and 5 show micrographic images from a video sequence captured on a droplet, viewed from the side, on superstrates coupled to a piezoelectric transducer. FIG. 4 shows a droplet on a plain silicon surface. FIG. 5 shows a droplet on a superstrate according to an embodiment of the invention.

FIG. 6 shows a plan view of an electrode structure for use on a transducer for use with an embodiment of the invention. The electrode overlap w is 15 mm, the finger width for each electrode is 170 μm and the finger pitch p is 330 μm.

FIG. 7 shows a schematic plan view of a disposable superstrate for use with an embodiment of the invention, including typical (but non-limiting) dimensions.

FIG. 8 provides a surface plot of the acoustic field intensity of a phononic cone structure illustrating the intensity at a first frequency of 12.62 MHz. FIGS. 8 and 9 illustrate the effect of different operation frequencies on SAW distribution at a sample manipulation surface.

FIG. 9 provides a surface plot of the acoustic field intensity of a phononic cone structure illustrating the intensity at a first frequency of 9.45 MHz.

FIGS. 10-13 show a series of consecutive frames from micrographic video footage of an embodiment of the device operating. These images clearly show that acoustic energy is being focused and reflected, and show sample nebulization.

FIG. 14 shows the dispersion curve for a free plate, with phase velocity as a function of excitation frequency.

FIG. 15 shows a schematic view of a device according to an embodiment of the invention. A separable phononic superstrate in the form of a phononic cone is shown coupled to a lithium niobate IDT.

FIG. 16 shows the size of droplets ejected during nebulization performed (a) on a phononic superstrate coupled to a piezoelectric transducer arrangement, and (b) directly on the surface of the piezoelectric transducer.

FIG. 17 shows movement of a droplet between cavities of a phononic cone.

FIG. 18 shows the band structure of a phononic lattice for use with embodiments of the invention. The forbidden band is in the frequency range 7.5 MHz to about 15 MHz.

FIGS. 19 (plan view) and 20 (side view) illustrate the nebulization of a sample from the surface of a LiNbO₃ piezoelectric transducer.

FIG. 21 shows schematically a sample droplet located on a dielectric superstrate, illustrating a problem to be solved by a preferred embodiment of the invention.

FIG. 22 shows schematically a sample droplet located on a dielectric superstrate, illustrating a preferred embodiment of the invention.

FIG. 23 shows schematically another embodiment of the present invention.

FIG. 24 shows schematic views of a superstrate provided with a suitable electrical connection for transferring charge from the piezoelectric transducer to the nebulization surface of the superstrate.

FIG. 25 shows a schematic view of an experimental set up to investigate charge transfer to nebulizing droplets.

FIG. 26 shows the results of the experiments based on FIG. 25.

### DETAILED DESCRIPTION OF THE PREFERRED EMBODIMENTS, AND FURTHER OPTIONAL FEATURES OF THE INVENTION

Surface acoustic waves (SAWs, the most common being Rayleigh waves) are acoustic waves that can be caused to travel along the surface of a material. Surface acoustic waves can be conveniently formed at the surface of a piezoelectric material by the application of a suitable electrical signal to an electrode arrangement at the surface of the piezoelectric material. A suitable electrode arrangement utilizes interdigitated electrodes, where a first electrode has an arrangement of parallel electrode fingers having a regular spacing between the fingers. A corresponding second electrode of similar shape has fingers which protrude into the gaps between the fingers of the first electrode. The combination of the electrode arrangement and the piezoelectric material forms a transducer.

A Rayleigh wave is a coupled compressional-shear system where the longitudinal and the transverse motion are out of phase by 90°. The present inventors have demonstrated that it is possible to propagate such longitudinal Rayleigh waves (an example of SAWs) from the piezoelectric device, through a coupling medium (which can, for example be water or an oil) into a thin disposable microfluidic chip superstrate formed of plastic, glass or other suitable material. Surprisingly, the waves carry sufficient energy to subsequently drive the fluids on the disposable substrate. Although the LiNbO₃ piezoelectric device is, itself, relatively expensive, in this format it is a re-usable platform, and it is only the superstrate that is disposed of after a (typically single) use. The only physical contact for actuation of the droplet is through the medium between the LiNbO₃ and the disposable chip.

When Rayleigh waves are propagated from a piezoelectric device to a superstrate (e.g. a thin chip) coupled to the surface of the piezoelectric device, the resultant acoustic waves in the substrate may be described as Lamb waves. Rayleigh waves and Lamb waves are types of surface acoustic waves. The term surface acoustic wave (SAW) is used herein to describe both Rayleigh waves and Lamb waves unless indicated otherwise.

Surface acoustic waves are longitudinal in nature, such that a component of the energy is dissipated in the z-plane (containing the coupling medium). This is in contrast with shear waves parallel to the plane of propagation, where no significant energy would be dissipated normal to the surface. As this longitudinal wave propagates within the coupling medium, it is subject to reflections off the lower (basal) plane of the disposable superstrate. Thus, by micromachining well defined structures within this plane (using established surface microengineering techniques including photolithography, pattern-transfer, mask definition and etching), it is possible to engineer complex energy distributions in the disposable superstrate. One particular application is the creation of plumes of nebulized samples, which can be captured in ion-funnels to provide an innovative interface between low volume (e.g. single cell) biology and mass spectrometry.

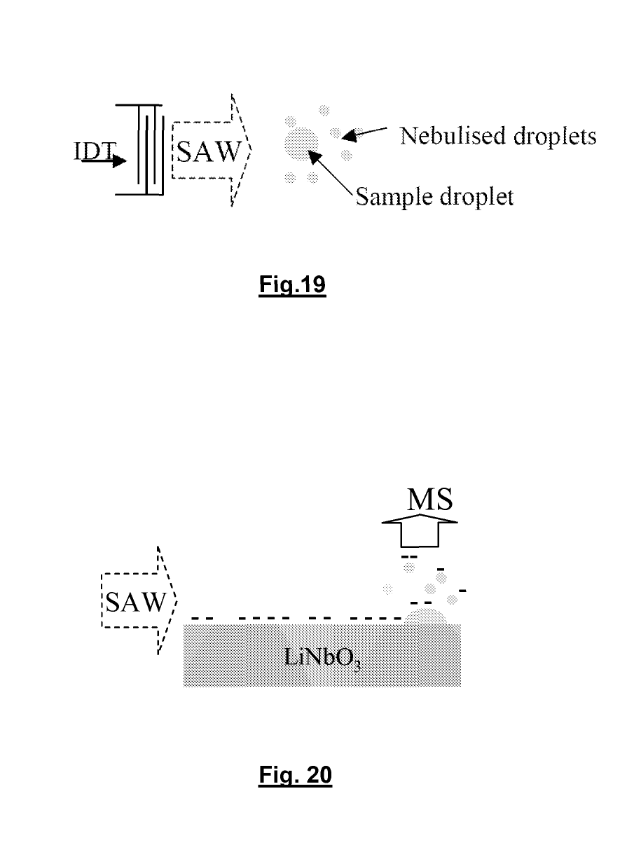

FIGS. 1-18, although they illustrate features of preferred embodiments of the invention, do not specifically show a feature identified as an electrical connection between the superstrate and the transducer. This feature is the subject of the discussion of FIG. 19 and on, below.

FIG. 1 shows a schematic example of a superstrate design for use with the present invention in plan view. The surface typically has a length of 20 mm and a width of 14 mm. The example of FIG. 1 is a funnel design, in which the sample manipulation zone 10 is bounded by a boundary zone 12. The boundary zone includes a phononic bandgap structure of holes formed in the surface. The holes are arranged in a two dimensional square lattice pattern. In this example, each hole has a radius of 176 μm. In this example, the spacing between the centres of adjacent holes is 374 μm.

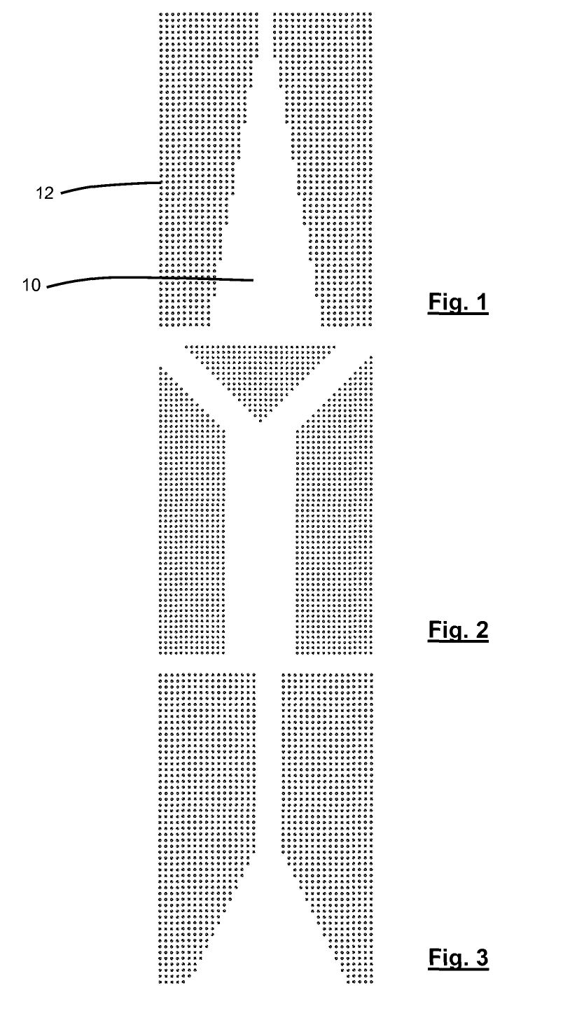

FIG. 2 is similar to FIG. 1, except that the design is a waveguide design.

FIG. 3 is similar to FIG. 1, except that the design is a combination design.

The SAW scattering elements can be formed by coating the surface with a suitable photoresist and a pattern transferred into the resist using photolithography. The pattern may consist of a square array of circular holes arranged to provide a funnel, a waveguide with split or combination of funnel and waveguide, as shown in FIGS. 1-3, respectively.

The photoresist pattern can be used as a dry etched mask where the holes are etched to a depth of approximately 230 μm or, more generally, a depth equivalent to about half the thickness of the superstrate. The superstrate may then be cleaned (e.g. in acetone).

The superstrate may then be cleaned again using an oxygen plasma treatment and then immersed in a solution of heptane and a tri-chloro-tri-deca-fluoro-octylsilane in order to give a hydrophobic surface, contact angle >65°.

The transducer was formed using a LiNiO₃ wafer with an interdigitated electrode structure. In some test experiments upon which the present work was founded, a suitable IDT was resonant at a frequency of 6.18 MHz and SAWs at this frequency were used for the tests. A programmable signal generator was used to provide an input of 6.18 MHz with amplitude of −10 dBm (1 μW) pulsed at 50 Hz to an amplifier with 40 dB gain to present approximately 10 dBm (1W) to the IDT.

De-ionised water was used as a coupling agent between the silicon test superstrates and the LiNiO₃ wafer; approximately 10 μL was used for this purpose. In order to test mobility and nebulization, the droplet size was about 2 μL.

During testing, each of the structures shown in FIGS. 1-3 influenced the movement of the water droplets on the sample manipulation surface. The structure that appears to function most efficiently is the funnel (FIG. 1) and this is primarily thought to be due to the relative size of the structure, although the inventors do not wish to be bound by theory in this regard. The funnel efficiently moves and focuses the drops to the focal point of the funnel irrespective of the initial starting point of the droplet in the sample manipulation zone. Although the test structures can be used multiple times their efficacy decreased with usage, as it can be difficult to adequately clean dried droplet stains from the exposed sample manipulation surface. This suggests that, where possible, the superstrate should be used only once and then disposed of.

The waveguide structure (FIG. 2) provides guiding of the water droplets and reduces or eliminates wander of the droplet trajectory on the sample manipulation surface that would be observed without the border zone. No splitting of droplets is typically observed although movement into either waveguide split may be observed.

The combination structure (FIG. 3) provides focusing of droplets to the waveguide structure and transit along the structure may also be observed.

Nebulization of water droplets can be achieved on all the structures shown in FIGS. 1-3. This is discussed in more detail below.

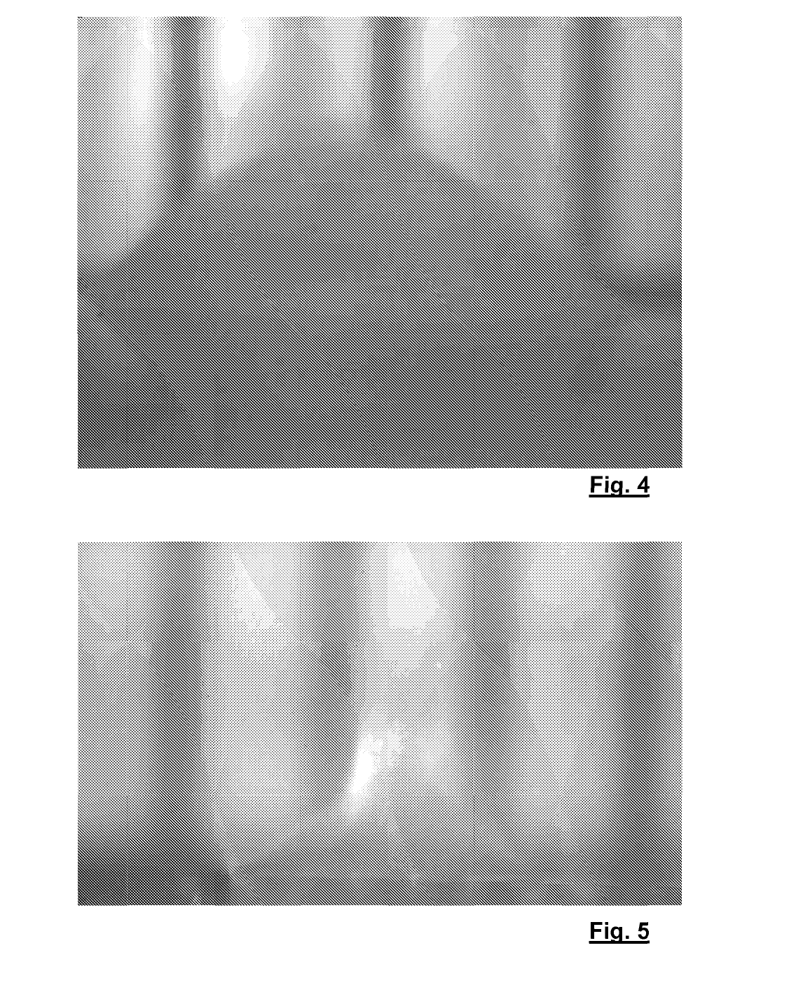

FIGS. 4 and 5 show micrographic images from a video sequence captured on a droplet, viewed from the side, on superstrates removably coupled to a piezoelectric device. FIG. 4 shows a droplet on a plain silicon surface without a border zone. FIG. 5 shows a droplet on a superstrate having a border zone with a phononic band gap structure similar to that described above. The image in each case is taken approximately 250 microseconds after the surface acoustic wave meets the droplet. As can be seen, more energy is transferred to the droplet in FIG. 5 than in FIG. 4. Each droplet has a volume of 1 μL. The power used in these experiments was 0 dBm input which supplied 5W at the IDT. The excitation frequency was 9.56 MHz. The dimensions of the superstrates were 2 cm by 1.5 cm. The amount of coupling fluid between the piezoelectric device and the superstrate was reduced to 4 μL—this provided a layer of approximately 13 μm thick. The superstrates were placed in the same position and were of the same thickness (450 μm).

Further details are set out below.

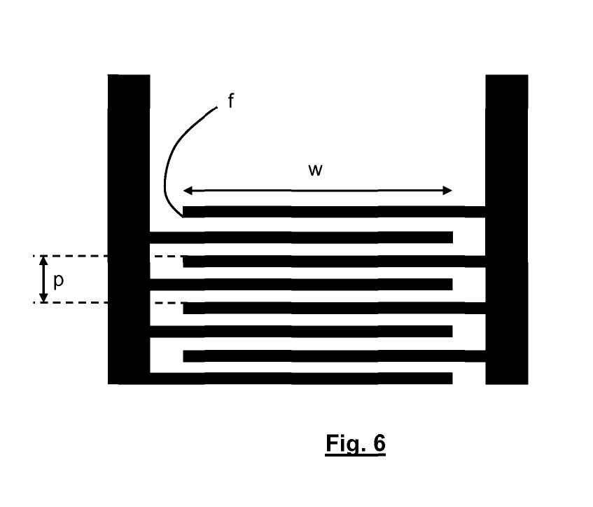

The electrode structures used 20 pairs of electrode “fingers” to form interdigitated transducers (IDT). The electrode “fingers” were located with approximately 330 μm pitch p, 180 μm finger width f, with 15 mm aperture w (overlap), see FIG. 6. The direction of overlap of the fingers can be considered to be a transverse direction of the IDT. The electrodes may be patterned using a lift off process where after photolithography, using acetate masks, a 20 nm adhesion layer of titanium is deposited prior to 100 nm of gold onto the wafer, lift off is then carried out in a beaker with acetone to produce the IDT electrodes for the apparatus.

An Agilent MXG Analog Signal Generator N5181A 250 KHz 1 GHz, in conjunction with a Mini Circuits ZHL-5W-1, 5-500 MHz amplifier, can be used to power the SAW device. The amplifier may be powered by a TTi EX354D Dual Power Supply 280 W which is capable of supplying 3A and ±24V DC. Approximately 1W of power may be applied to the IDT. The driving signal for the SAW device can be pulsed for 20 ms every 100 ms, to avoid excess heating. Droplets can be imaged at 62 frames per second using a high speed camera (Red Lake M3), allowing the capture of nebulization from single pulses to be visualized, when the surface acoustic waves travel through the droplet.

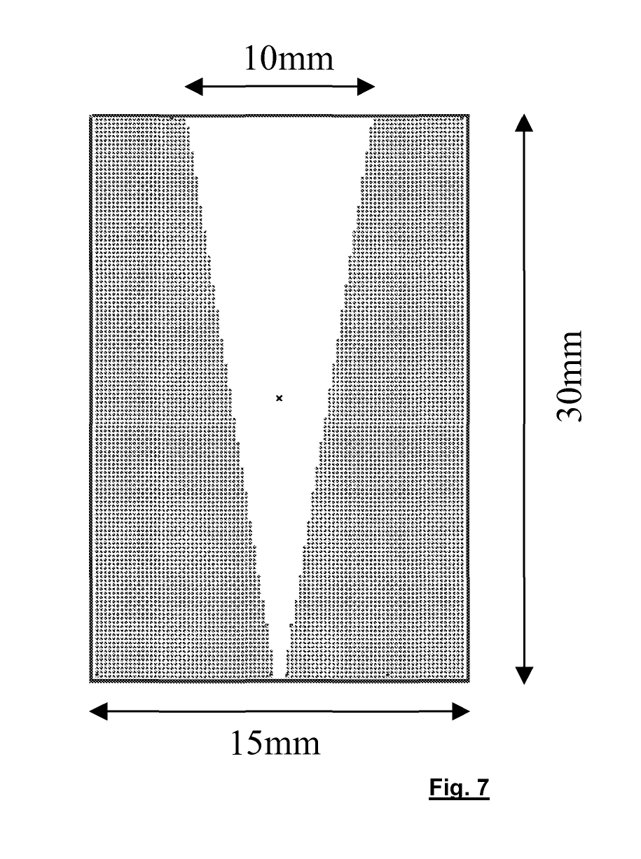

FIG. 7 shows a schematic plan view of the configuration of a manipulation surface for use with an embodiment of the invention. The dimension of the cone patterned surface is approximately 15 mm by 30 mm. The aperture for the cone is 10 mm and the apex is approximately 0.57 mm (corresponding to two holes missing).

In order to illustrate nebulization, two 1 μL drops of deionised water can be used, one at the apex of the cone, the other approximately 10 mm away from the apex.

The phononic structure in the border zone consists of a square array of holes etched into the surface, to a depth about half way through the piezoelectric layer. This regular perturbation in the Young's modulus of the material provides the material with a frequency dependent acoustic transmission or reflection property.

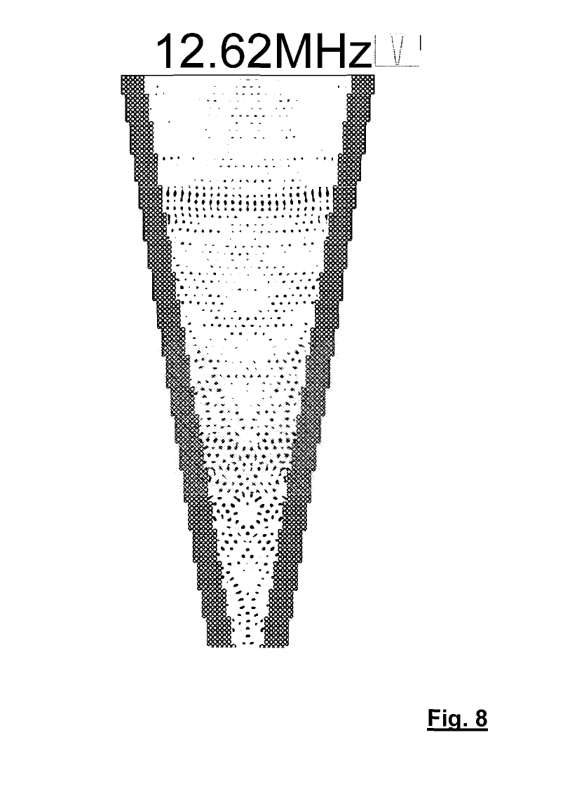

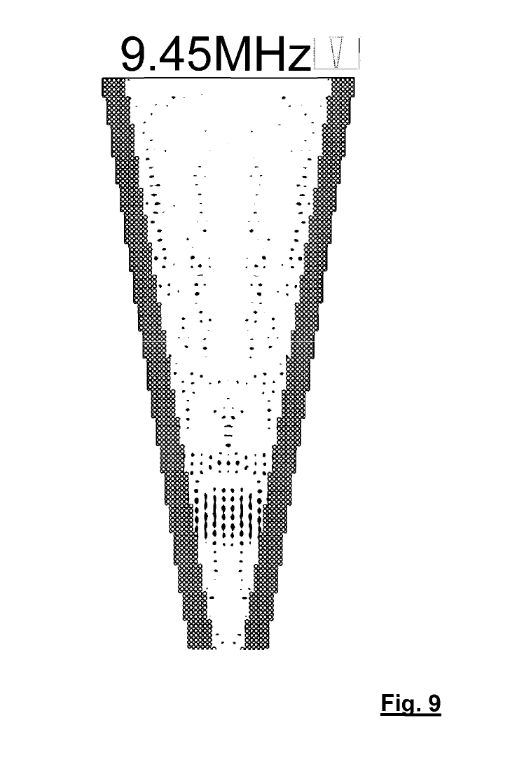

Surface plots of the acoustic field intensity of a phononic cone structure illustrating the intensity at a frequency of 11.36 MHz and at a frequency of 11.56 MHz are shown in FIGS. 8 and 9 of W02011/023949. These plots together show the effectiveness of the phononic structure to confine the acoustic field depending on the frequency used: a change of 200 KHz from 11.36 MHz to 11.56 MHz can provide a 3 dB change in intensity.

FIGS. 8 and 9 illustrate the effect of SAW frequency on the mode of operation of the apparatus. In FIG. 38, a phononic array is modelled at a SAW frequency of 12.62 MHz. The effect of this is to set up a particular distribution of SAWs at the sample manipulation surface. In FIG. 39, the same phononic array is modelled at a SAW frequency of 9.45 MHz. The effect of this is to set up a different distribution of SAWs at the sample manipulation surface.

The present inventors aimed to find the resonant frequency of the IDT to obtain the most efficient frequency to nebulize the drops from the manipulation surface. In this case 12.85 MHz is found to be the resonant frequency for the IDT and droplet nebulization from the manipulation surface. However, this frequency of operation may not provide suitable operation of the phononic structures in the border zone. It is observed that by reducing the excitation frequency for the IDT down to 12.64 MHz a dramatic increase in nebulization is observed on the superstrates with phononic structures. The increase in substrate activity is more than enough to compensate for any decrease in IDT acoustic conductance (the amount of electrical power that can be transformed into mechanical power).

The wavelength of the SAW depends on the pitch of an IDT. However, the observed change in acoustic response of the phononic structure would indicate a change in the wavelength of the SAW and hence variation in the pitch of the interdigitated electrodes. This variation can be a consequence of using acetate masks for prototyping. Such masks may posses a variation in the electrode thickness that might normally be thought to be insignificant, but it seems that they may indeed be significant. So in effect the inventors use an IDT with a range of pitches allowing a number of possible wavelengths to be radiated.

In an alternative embodiment, the transducer uses a slanted interdigitated electrode structure. This is then used as a tunable source of SAWs. By slanting the electrodes the inter-electrode distance changes with lateral position across the electrode structure. This arrangement can be modelled by an array of IDTs with differing inter electrode spacing. The position of the SAW depends on the excitation frequency used.

It is possible to design a device for use at a certain operating wavelength (frequency) but typically there are always some deviations from the design parameters due to manufacturing tolerances during fabrication. As shown in FIGS. 8 and 9, the phononic structures are highly frequency/wavelength dependent. Therefore, by varying the excitation frequency slightly away from the predicted operating frequency, it is possible to tune in to a useful operating regime where the SAW wavelength is shifted enough to allow the device to function substantially as designed.

FIGS. 10-13 show a series of consecutive frames from video footage of a fluid manipulation apparatus operating. These images clearly show that acoustic energy is being focused and reflected.

In FIGS. 10-13, two 1 μL droplets have been placed onto the manipulation surface. The first droplet is directly in the path of the second droplet, about 10 mm behind the first droplet. The second droplet should in effect “steal” some of the acoustic energy before the acoustic energy can reach the other first droplet. Despite this, nebulization was observed only for the first droplet, at the apex of the phononic cone. The length of the substrate in this case was 30 mm. The power used in this case was five times lower than in the experiments reported above.

Nebulization for 0.5 μL drops has been observed at 790 mW applied power.

FIG. 10 shows the first of a series of frames taken from a movie captured at 62 frames per second. This first image is just prior to an ultrasonic SAW pulse arriving at the droplets at about 4000 m/s. Approximately 1W of power was applied to the IDT.

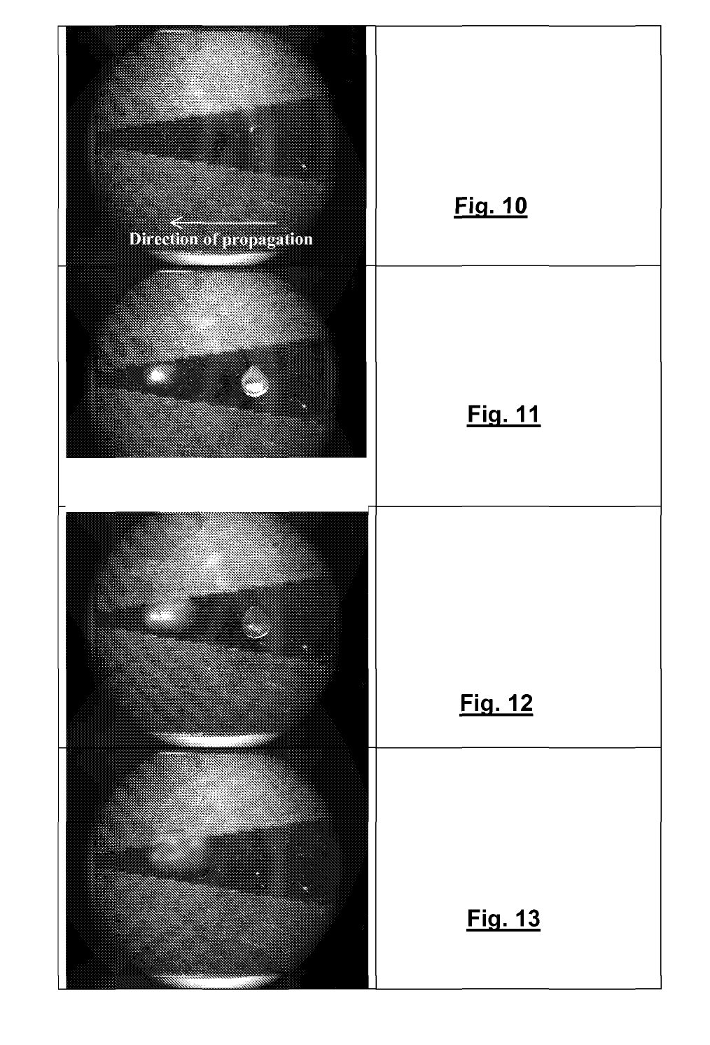

FIG. 11 shows the droplets irradiated by the SAWs with the second droplet clearly agitated but not nebulizing, whereas the first drop near the apex of the cone is nebulizing.

FIG. 12 shows a frame in which the 20 ms pulse has stopped but some free oscillation in the drops can be observed. It is interesting to note that the drop that was nebulizing was in the shadow of the second drop and would normally experience much less acoustic radiation as the second drop would absorb a significant amount of the Rayleigh wave energy.

In FIG. 13 the oscillations have stopped and only the plume expelled from the first drop can be seen. This illustrates the efficacy of the device.

The design, construction and investigation of the device shown in FIGS. 10-13 will now be described in more detail. Note that the device used in FIGS. 10-13 was a removable superstrate coupled to a piezoelectric transducer via a coupling medium.

The surface acoustic waves were generated on the piezoelectric LiNbO₃ wafer by an interdigitated transducer (IDT) and propagated as Rayleigh waves, in a non dispersive manner with a single velocity. The resonant frequency, f0, is directly related to the Rayleigh wave velocity in the material, cR, (3996 m/s), the SAW wavelength λ and the pitch of the interdigitated electrodes, D, as per equation (1):

$$λ = \frac{{c}_{R}}{{f}_{0}} = 2 D \qquad ( 1 )$$

The Rayleigh waves were coupled into a superstrate in the form of a sheet, or plate (which superstrate sheet or plate may be referred to as a chip), via an intermediate thin film of water. As a free plate, the superstrate supports a number of propagation modes, termed Lamb waves (named after Lamb, the first to carry out the analysis). There are two distinct classes of Lamb wave propagation modes, symmetric and antisymmetric, that can be resolved using the Rayleigh-Lamb frequency equations (2) and (3).

$$\begin{matrix}\frac{tan ( \frac{qd}{2} )}{tan ( \frac{pd}{2} )} = - \frac{4 {k}^{2} pq}{{( {q}^{2} - {k}^{2} )}^{2}} , \\ symmetric modes & ( 2 ) \\ \frac{tan ( \frac{qd}{2} )}{tan ( \frac{qd}{2} )} = - \frac{{( {q}^{2} - {k}^{2} )}^{2}}{4 {k}^{2} pq} , \\ antisymmetric modes & ( 3 )\end{matrix}$$

where

$${p}^{2} = {( \frac{\overline{ω}}{{c}_{L}} )}^{2} - {k}^{2} , \\ {q}^{2} = {( \frac{\overline{ω}}{{c}_{T}} )}^{2} - {k}^{2} ,$$

and k=2π/λ= ω̅/cₚₕₐₛₑ with d the plate thickness, and cL (8433 m/s) and cT (4563 m/s) the longitudinal and transversal velocities, respectively.

These transcendental equations, with many real solutions, reveal that Lamb waves are dispersive, as the phase velocity, cₚₕₐₛₑ, is a function of the frequency thickness product f×d. Thus for a fixed frequency, the wavelength and the mode propagated in the superstrate sheet can be controlled via its thickness.

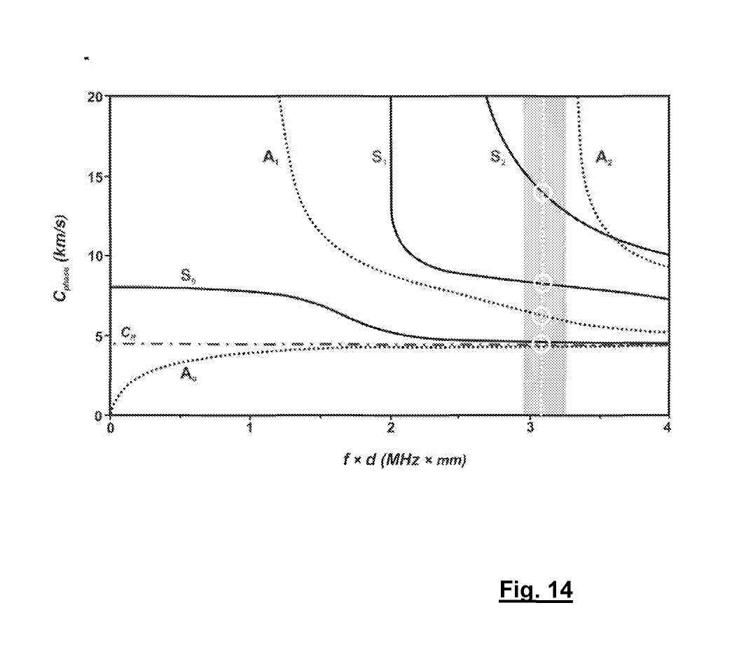

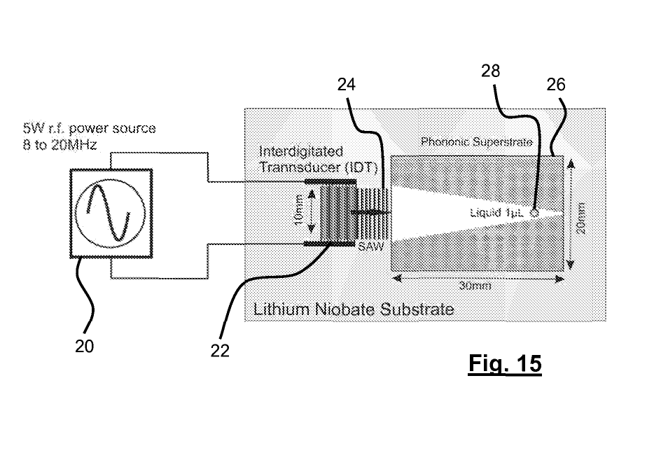

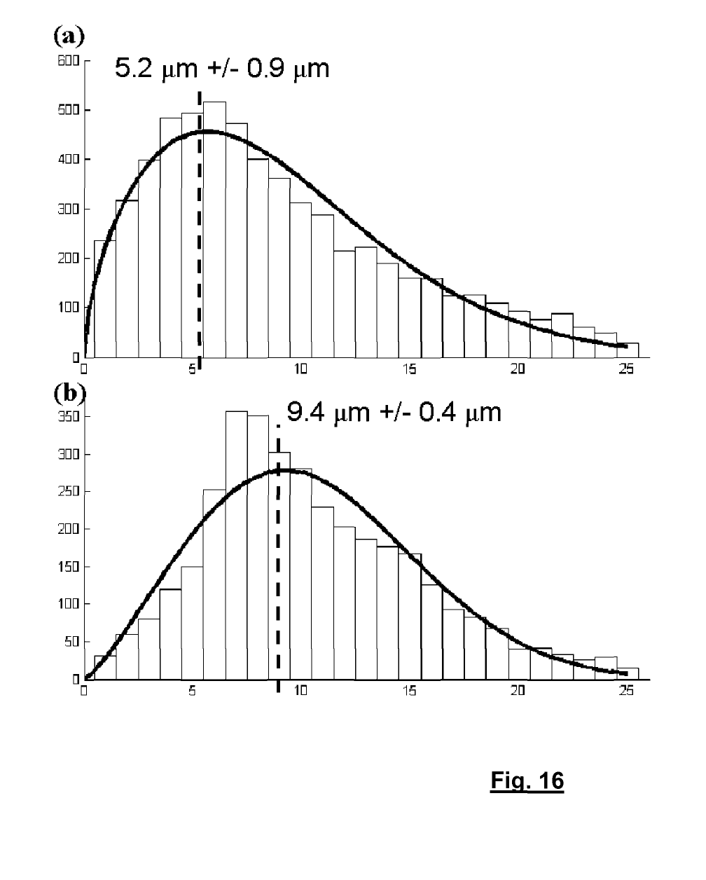

FIG. 14 shows the dispersion curve for a free plate, with phase velocity as a function of excitation frequency. At 12.6 MHz, two asymmetric and three symmetric modes can be excited. The phase velocities of the lowest order modes A₀ and S₀ are the closest to that of the propagating Rayleigh wave in the substrate sheet (Cₚₕₐₛₑ, 3996 m/s), which the inventors worked with, and thus these modes are excited in preference to higher order ones. The inventors used these data, together with previously published criteria for phononic plate structures [Djafari-Rouhani B et al. (2008) Absolute band gaps and waveguiding in free standing and supported phononic crystal slabs. Photonics and Nanostructures—Fundamentals and Applications 6:32-37] to design phononic structures to manipulate fluid.

These phononic structures were then modelled as simple 2-D diffraction problems, where the acoustic waves were described using a time harmonic Helmholtz wave equation (4), in which a pressure wave, P, was launched into the structure (density ρ), over a range of wavelengths calculated from the Lamb wave number, k, at a particular (fd) product.

$$- ∇ \cdot ( \frac{1}{ρ} ∇ P ) - \frac{{k}^{2} P}{ρ} = 0 \qquad ( 4 )$$

The inventors developed simple phononic structures, where the lattice comprises an array of holes, and where all cases were treated with Neumann boundary conditions. Using these design criteria the inventors produced a series of square lattice 2D phononic crystals, which amplified or shaped the acoustic field, within the superstrate sheet. The phononic crystal was used to create acoustic cavities, which were excited at different wavelengths, resulting either in scattering or reflection of the energy. This can focus the energy into specific regions of the chip. As a consequence, the interaction between the Lamb wave and the phononic lattice generates spatial variations of the acoustic field intensity, associated with the different propagation regimes within the chip.

Importantly, energy losses that occur during the coupling of the acoustic wave from the lithium niobate wafer into the superstrate sheet are mitigated against by the phononic structure, which can focus the power into specific regions of the chip.

The Lamb waves propagated in the chip interact with the droplet of liquid placed on its surface in a similar fashion as Rayleigh waves in a piezoelectric material would. In the case of Rayleigh waves, the interaction with the liquid dampens the surface-propagating wave, which decays as it propagates along the surface. It is then termed a leaky Rayleigh wave and radiates a compressional wave into the liquid, which cannot support shear waves. Similarly, a droplet of liquid placed on the superstrate renders the Lamb waves evanescent, with the acoustic energy being refracted into the liquid at an angle termed the Ralyeigh angle θ_{R}, determined by Snell's law (equation 5) relating the speed of the waves in solid and liquid:

$$sin {θ}_{R} = \frac{{c}_{liquid}}{{c}_{solid}} \qquad ( 5 )$$

Depending on the power applied, different fluidic regimes can be induced in the droplet, from (acoustic) streaming where volumetric flow is created throughout the drop by recirculation, to the destabilisation of the contact line resulting in droplet movement, as well as nebulization and jetting by disrupting the drop's free surface into smaller droplets. Examples of the spatial control of the acoustic energy upon the different regimes on the phononic superstrates are described in more detail below.

The SAW device was fabricated on a 128° Y-cut X-propagating 3 inch LiNbO₃ wafer, each device consisted of 20 pairs of electrodes to form an inter-digitated transducer (IDT) with pitch of 160 μm, 80 μm width, and a 10 mm aperture. The SAW IDTs were patterned using a lift off process where, after pattern transfer into an S1818 resist, a 20 nm titanium adhesion layer was evaporated prior to deposition of 100 nm of gold. Lift-off was then performed in acetone, in order to realise the pattern.

An Agilent Technologies MXG Analog Signal Generator N5181A was used in conjunction with a Mini Circuits ZHL-5W-1, 5-500 MHz amplifier and a 3A, ±24V DC power supply to power the SAW device. For nebulization experiments, the driving signal for the SAW device was pulsed for 20 ms every 100 ms, to avoid heating. Droplets were imaged at 62 fps using a Red Lake M3 high-speed camera mounted on a Leica upright microscope, which allowed the capture of nebulization from the droplets to be visualized, when the surface acoustic waves travelled through the droplet. The IDT's were characterised using an Agilent Technologies E5071C ENA series network analyser.

The superstrate was fabricated using silicon wafer with an approximate thickness of 470 micrometre. The 4 inch Si wafer was coated in AZ4562 photoresist and patterned using standard photolithography. The pattern comprised a square array (pitch 203 micrometre) of circular holes (radius 82 micrometre) and was transferred into resist layer. The photoresist pattern was then transferred into the silicon using dry etch (STS ICP) where the holes were etched. The wafer was cleaned in acetone and cleaved to provide the superstrates. The dimension of the patterned superstrate was approximately 20 mm by 30 mm. In the case of the acoustic horn, the aperture for the cone was made to be 10 mm to coincide with the IDT aperture and the apex of the cone was approximately 1.22 mm wide. (In the case of the centrifugal filter, described further below, the same square array of circular holes was used and actuation of the fluid was observed with 10 micrometre polystyrene beads (Duke Scientific G1000).) A 5 microlitre volume of de-ionised water was placed between the superstrate and the transducer surface to provide a coupling layer approximately 50 micrometre thick to promote SAW coupling.

A schematic of the device is shown in FIG. 15, which depicts the application of sinusoidal wave from a 5W rf power source 20 (operable in the range 8 to 20 MHz) to the interdigitated transducer (IDT) 22 having an aperture of 10 mm to generate a Rayleigh Wave (SAW) 24. The SAWs on the LiNbO₃ wafer surface induce Lamb waves in the superstrate 26 coupled to the LiNbO₃ wafer surface, where the intensity was focused at the 1 μl drop 28. The IDT electrodes had a pitch of 160 micrometre, electrode widths of 80 micrometre and an aperture of approximately 10 mm. The phononic crystal comprised holes of 82 micrometre radius with a pitch of 203 micrometre, to provide a fill factor of 0.8, etched into [100] silicon (where structure was aligned to the [011] direction of the silicon wafer, the propagation direction of the Lamb waves was parallel to the [011] direction).

The phononic superstrate was designed in the form of a phononic cone in order to focus the acoustic energy, as a series of steps (or cavities), with each feature being resonant at a particular frequency, and acting as a Fabry Perot cavity [Qiu C, Liu Z, Mei J, Shi J (2005) Mode-selecting acoustic filter by using resonant tunneling of two-dimensional double phononic crystals. Appl. Phys. Lett. 87:104101-104103; Wu T T, Hsu C H, Sun J H (2006) Design of a highly magnified directional acoustic source based on the resonant cavity of two-dimensional phononic crystals. Appl. Phys. Lett. 89:171912-171913].

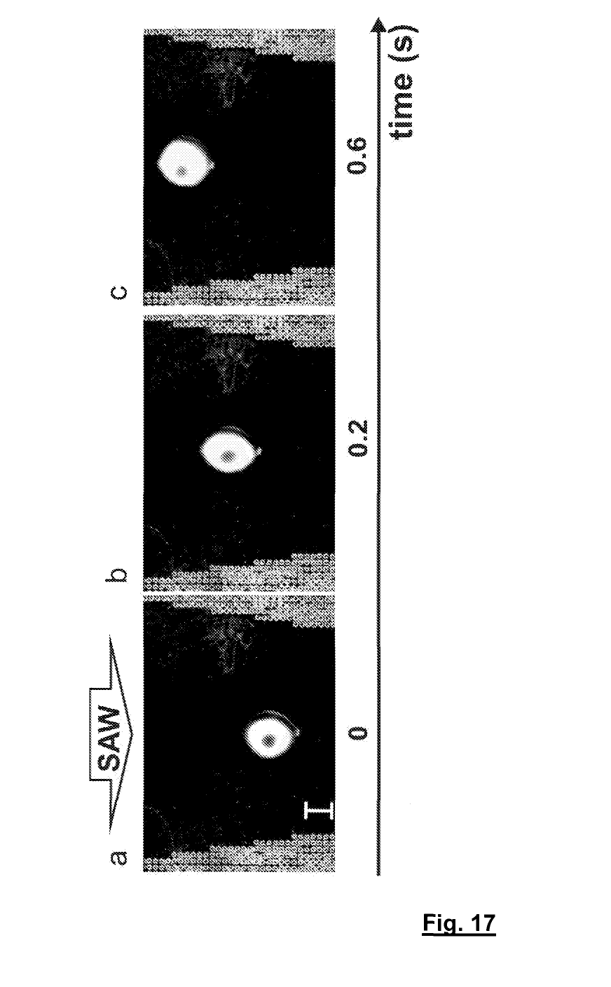

Six steps, or cavities, of the phononic cone were identified. The inventors reviewed micrographic stills (not shown here) from a movie captured at 62 fps before and during nebulization, with the device being excited at 12.6 MHz with an applied power of 1.25 W. Before nebulization, with a droplet in the fourth cavity, the droplet was quiescent and its position could only be seen from light reflections. Next, the droplet in the fourth cavity is nebulized, whilst that in a different cavity was agitated, and thus became visible, but was not nebulized. The images referred to here are shown as FIGS. 17b, c and d in WO2011/023949.

Acoustic waves on the surface of the superstrate, within the phononic structure were observed using white light interferometry, and the wavelengths measured on both the LiNbO₃ wafer and on the superstrate within the phononic structure. The inventors chose an excitation frequency of the IDT, driving the SAW, in order to excite particular cavity modes within the phononic superstrate (i.e. cavities 1 to 6 referred to above). For example, the fourth cavity readily accommodated the contact area of the drop and was excited at 12.6 MHz.

Simulations were carried out of the phononic cone structure when excited at 12.6 MHz and 13.2 MHz respectively. Standing waves develop as a consequence of the sidewalls acting as a series of Fabry Perot etalons. The standing waves in the cavities are of up to an order of magnitude larger than the acoustic field on an unmodified superstrate (a superstrate with no phononic lattice), depending on the frequency. Each cavity could be excited at different frequencies, where there was about 300 KHz spacing between each cavity (i.e. between cavities 1 and 2; between cavities 2 and 3, etc). For example the second cavity showed the highest enhancement factor of about 10 at 13.2 MHz whereas the fourth cavity showed an enhancement of about 6 at 12.60 MHz excitation. The phononic cone was modelled as a simple 2-D diffraction problem using COMSOL Multiphysics v3.5a.

The simulations showed that different cavities of the device can be excited at different frequencies. The device has been designed so that the phononic structure acts as an efficient reflector and little energy is dissipated into the lattice. The simulations also show that the spatial variation in acoustic intensities, as well as the generation of standing waves, were perpendicular to the direction of propagation of the Lamb waves. Changes in frequency of 0.6 MHz can provide significant variations in acoustic field intensity, a fact corroborated experimentally.

The nebulization phenomenon has been studied further. When relatively high powers are applied, the acoustic energy overcomes the surface tension pinning the drop to the surface so that it spreads out in a liquid film and gives rise to capillary resonance waves in the liquid which are determined by internal viscous damping and inertial forcing of the drop. These capillary waves have a wavelength on the order of the diameter of the nebulized drops with volumes in the sub-picolitre range. The nebulization of a 1 microlitre droplet proceeding on the phononic superstrate has been monitored. The droplet was placed in a cavity of the cone phononic superstrate and nebulized using SAWs excited with a frequency of 12.6 MHz and a power of 4 W. FIG. 16 shows the size of droplets ejected during nebulization. Nebulization of water droplets (1-2 microlitres) was performed on the cone phononic superstrate coupled to the piezoelectric transducer arrangement (FIG. 16a) or directly on the surface of the piezoelectric transducer arrangement (FIG. 16b) with excitation frequencies around 12 MHz (+/−1.2 MHz). The size of the droplets ejected was measured with a Phase Doppler Particle Analyser. The data set from each experimental run (with multiple runs per condition) was fitted with a Weibull distribution and the modes extracted using Matlab (R2010a, The Mathworks, Inc.). An example of the fitted distribution, superimposed on the histogram, is shown for one run for each condition. Values presented are the average of the modes obtained for each condition with the standard deviation. Interestingly this data also shows that droplets nebulized on a phononic superstrate are smaller than on the IDT. However, the droplet size distribution was sharper when the nebulization was carried out directly from the piezoelectric layer surface. Two other modes not associated with nebulization were observed, with droplets sizes centred around 50 μm and 150 μm, resulting from jetting phenomena. The diameter of the droplets nebulized from the surface of the phononic cone superstrate was measured at 5.2 micrometre (+/−0.9 micrometre), and was not significantly different from a nebulization happening on an unstructured superstrate. However, a major difference with using an unstructured superstrate lies in the large variation in the extent of nebulization on the phononic superstrate, which is dependent upon where the droplet was placed within the cone. This precise spatial control of the acoustic field is also seen experimentally. Excitation of the droplet in the fourth cavity at 12.6 MHz resulted in nebulization, whilst there is no excitation 10 mm away, in cavities within the trumpet of the cone. The spatial control of the acoustic energy also enabled the reproducible placement of the drop on the phononic superstrate as it aligned itself to the excited cavity when deposited around it, as described further below.

Droplet movement and splitting was also observed, as described below.

When the acoustic radiation applied or coupled in the superstrate overcomes or is equal to the sliding force Fₛ given by equation (6), droplet movement can be achieved.

$${F}_{s} = 2 R {γ}_{LG} sin ( \frac{{θ}_{a} + {θ}_{r}}{2} ) ( cos {θ}_{r} - cos {θ}_{a} ) \qquad ( 6 )$$

In equation (6) R is the radius of the drop, γ is the surface tension and θₐ and θᵣ are the advancing and receding contact angles of the drop when no acoustic wave is applied.

By placing a droplet between two cavities, one of which is resonant, the spatial variation of the acoustic energy densities, results in acoustic forces on the droplet which splits and/or moves of the droplet as it moves towards the cavity with the higher energy. By tuning the strength and frequency of the field in the cavities, relative to each other, droplets will either divide symmetrically or asymmetrically. The process of droplet movement or division is driven by refracted waves (one direction) and reflected waves in the opposite direction (back from the phononic cone). The mobility of the drop can be improved by reducing the contact angle hysteresis, by making the surface hydrophobic. For example, a 5 microlitre water droplet was observed to move back and forth between 3 cavities of a phononic cone treated with a hydrophobic silane. FIG. 17 shows the movement of a 5 microlitre water droplet between three cavities of a phononic cone, at different times (a. 0 seconds; b. 0.2 seconds; c. 0.6 seconds), when the exiting frequency is changed from 12.23 MHz (a) to 12.43 MHz (c) with increments of 0.1 MHz

The propagation of the SAW directly on the piezoelectric wafer or an unstructured superstrate coupled to the piezoelectric wafer resulted in droplet movements in the same direction as the SAW, whereas on the phononic superstrate, the droplet was moved in the opposite direction to the SAW, by increasing the frequency from 12.23 MHz to 12.43 MHz (−3 dBm). It was brought back to the same position by decreasing the frequency from 12.43 MHz to 12.23 MHz.

The same transducer arrangement as described above, used for droplet nebulization, splitting or movement, can be used to create an on-chip “centrifuge” (more correctly “separator”, as discussed above, but others in the art use the term “centrifuge”), by using a different superstrate, coupled to the transducer arrangement, as described below.

The device used for centrifugation of particles within fluid droplets is shown schematically in FIG. 20a of W02011/023949. The transducer arrangement and superstrate were made as described above, except the phononic lattice was formed as a square, rather than as a cone.

Simulation results (Comsol multiphysics 3.5a) investigated where a pressure wave was propagated in the superstrate at 12.6 MHz and has its symmetry broken by the phononic lattice. These results show that the phononic structure generates a difference in speeds of the induced Lamb wave in the superstrate, breaking the symmetry of the acoustic wave and inducing angular momentum within the sample. The resulting flow patterns concentrate particles within the liquid, due to fluid motions which have similarities to those described by Batchelor [Batchelor GK (1951) Note on a class of solutions of the Navier-Stokes equations representing steady rotationally-symmetric flow. Q. J. Mech. Appl. Math. 4:29-41; Raghaven R V, Friend J R, Yeo L Y (2010) Particle concentration via acoustically driven microcentrifugation: microPlV flow visualization and numerical modelling studies. Microfluid. Nanofluid. 8:73-84].

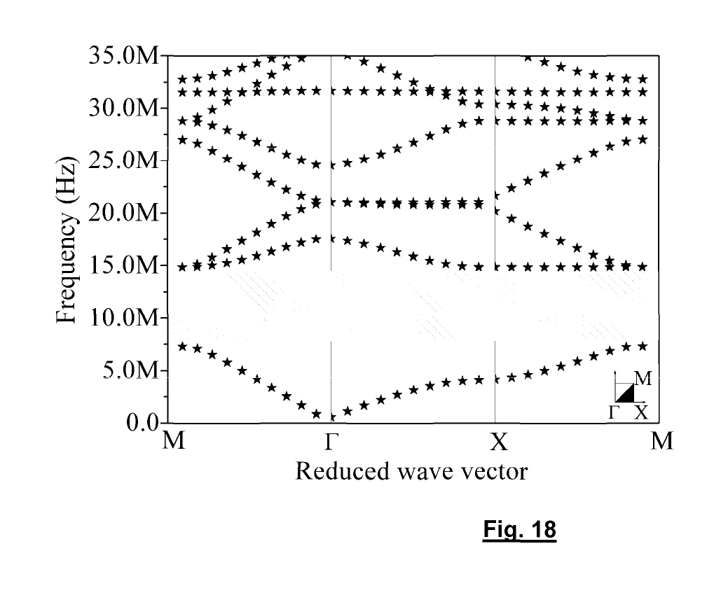

FIG. 18 shows the band gap of the square phononic array. The wave propagation was investigated using the two-dimensional plane wave expansion method [Hsu J and Wu T, (2006) Efficient formulation for band-structure calculations of two-dimensional phononic-crystal plates. Phys Rev. B, 74, 144303]. As will be understood by the skilled person, this type of reduced wave vector diagram is a convenient way to describe band gaps in symmetrical structures. Thus, in this example, where a phononic crystal has a particular symmetry, it is not necessary to consider all the possible propagation directions of a wave in the crystal. But by taking the symmetry of the structure into account it is only necessary to consider propagation in a reduced number of directions; for a square lattice (as in this example) we only need to take directions from 0 to pi/4 radians (0 to 45 degrees) with respect to one of the reciprocal lattice vectors of the crystal. The reciprocal lattice is the Fourier map of the crystal (or its diffraction pattern), where the wave vector of a wave is the direction of propagation with respect to the reciprocal lattice.

For isotropic materials, it is only necessary to consider one direction of propagation, or one wave vector. The forbidden area corresponds to the absolute band gap from 7.67 MHz to 14.48 MHz. These data complement the simulation, which showed the wave filtered by the phononic structure when propagated at 12.6 MHz.

In order to better understand the flow patterns generated by this type of phononic structure, the inventors explored the behaviour of beads within these flows. The results are shown in FIGS. 20c and 20d of W02011/023949 and the associated text of that document describing those drawings.

Where a sample containing an analyte is nebulized for analysis by mass spectrometry, charging of the analyte is necessary. In the preferred embodiments of the invention, the nebulized droplets are negatively charged. However, it is possible to positively charge the droplets, as will be understood by those skilled in the art.

FIGS. 19 (plan view) and 20 (side view) illustrate the nebulization of a sample from the surface of a LiNbO₃ piezoelectric transducer. It is considered by the inventors, without wishing to be limited by theory, that charge is transferred to the sample from the SAWs moving along the piezoelectric material surface, as indicated in FIG. 20.

FIG. 21 shows a sample droplet 100 located on a dielectric superstrate 102. The superstrate is coupled to the surface of the LiNbO₃ piezoelectric transducer 106 by a coupling medium such as water 104. However, the sample droplet is electrically insulated from the surface of the LiNbO₃ piezoelectric transducer 106, because the superstrate 102 is formed from an electrically insulating material, or at least a material that has a resistivity that is too high, e.g. Si, or boron-doped Si. Therefore the nebulized sample is not adequately charged for mass spectrometry.

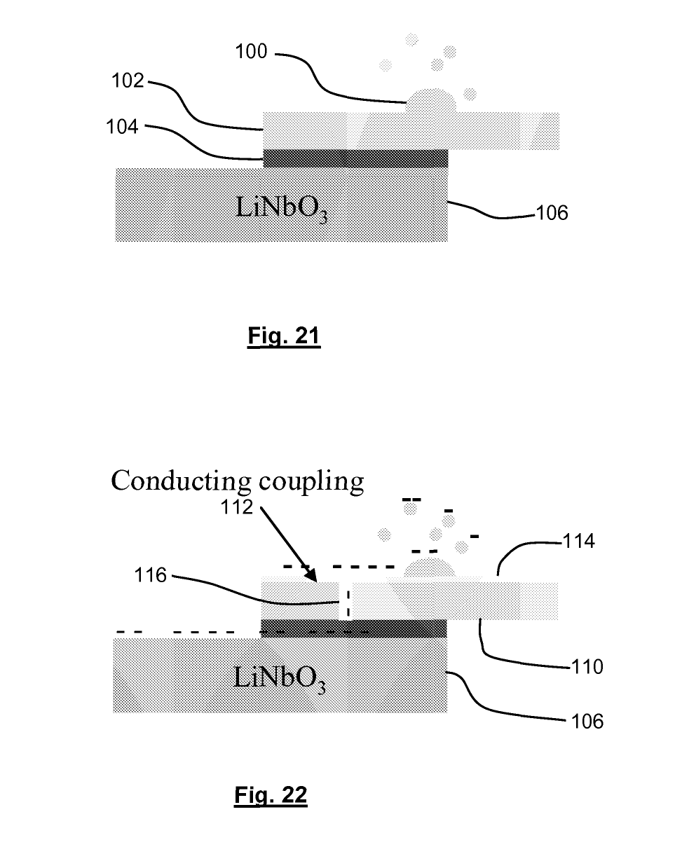

A solution to this problem is shown in FIG. 22. Here, a dielectric superstrate 110 is coupled to the surface of the LiNbO₃ piezoelectric transducer, as in FIG. 21. However, a conductive coupling 112 is provided, giving a conductive path to the upper (second) surface of the superstrate. This allows charge to be transferred from the piezoelectric substrate 106 to the sample droplet, which in turn allows the nebulized droplets containing analyte to be charged for suitable manipulation by the mass spectrometer. The plume derived from the device of FIG. 22 can be controlled using an electric field created by an external source. Thus, there is provided controllable nebulization for mass spectrometry from a disposable substrate without the use of matrix (as in MALDI) or high voltages (as in ESI).

In the example shown in FIG. 22, the conductive coupling 112 is provided in the form of a conductive film 114 on the second surface of the superstrate and a conductive via 116 extending through the depth of the superstrate to be in electrical contact with the coupling medium. The conductive film 114 may extend across the whole area of the second surface of the superstrate, or may be confined to the region where the sample is placed. In alternative embodiments, the conductive coupling may be in the form of a conductive track (e.g. of gold, or of conductive paint) extending around the side(s) of the superstrate to contact the coupling medium. In further alternative embodiments, the conductive coupling may be provided in the form of a resilient solid electrical connection from the second surface of the superstrate to the surface of the SAW transducer. For example, a metallic ribbon connection may be used. Such a connection has the advantage that it does not rely on the electrical conductivity of the coupling medium. However, such a connection may act to dampen the SAWs, which is not preferred.

An alternative solution may be provided by considering a modification of the arrangement of FIG. 21. In this modification, the superstrate may be formed of a conductive material, e.g. a metal. For example, the superstrate may be formed from a relatively inexpensive material (e.g. stainless steel, aluminium, etc.) with a conductive and protective coating layer (e.g. gold). In this way, the entire superstrate provides a conductive path from the second surface of the superstrate to the SAW transducer substrate (via the coupling medium).

A further embodiment of the invention (not illustrated) provides a charge source in the form of a terminal of a DC power source. The second surface of the superstrate has a conductive film formed on it, as in FIG. 22, but the conductive via through the superstrate is replaced by an electrical connection from the second surface of the superstrate to the terminal of the DC power source. In this manner, the second surface of the superstrate can be held at a required potential, in order to charge the nebulizing droplets either positively or negatively. One advantage of this approach is that it allows the SAWs to be generated by means which may not be coupled with charge-generation mechanisms. For example, in this embodiment, the transducer may be formed of a material other than a piezoelectric material. The SAWs may be generated, for example, by a pulsed laser cyclically heating the transducer material in order to generate the required mechanical waves.

FIG. 23 shows a further embodiment of the invention. This differs from FIG. 22 in that the geometry of the device of FIG. 23 is not based on a planar arrangement. Instead, a “superstrate” is in the form of a sample tube 120 (e.g. a hollow needle), the bore of the sample tube 120 being supplied with a sample fluid 122 containing the analyte. The sample tube in this example may be a metallic tube. In other embodiments, the sample tube 120 may be formed from an insulating material, but with a conducting path 124 provided to the sample fluid contained in the bore of the sample tube. The sample tube itself is held in a tubular transducer 126, coupled to the transducer by a coupling medium 128. The tubular transducer 126 may be formed from a piezoelectric material. For example, the tubular transducer may be formed from a polycrystalline piezoelectric material (the use of polycrystalline piezoelectric material assists in the manufacture of the device as compared with a single crystal). For example, the piezoelectric material may be in the form of a piezoelectric coating on a tubular support substrate. An IDT 130 is formed on the internal surface of the piezoelectric tube to form the tubular transducer. Operation of the transducer causes the generation of SAWs and the accompanying charge at the surface of the transducer 126. The SAWs propagate along the internal surface of the transducer and couple to the hollow sample 120 tube via the coupling medium 128. The sample 122 in the sample tube is nebulized from the end of the sample tube. The electrical connection 124 provided between the inner surface of the sample tube and the surface of the transducer allows the charge propagating along the surface of the transducer to transfer to the sample tube and then to the nebulizing droplets 132.

In a modification of FIG. 23, it would be possible for the sample tube to be placed around a cylindrical (or tubular) SAW transducer, with the sample fluid to be located at the outer surface of the sample tube.

The inventors have further considered the likely principles underlying the invention, without wishing to be bound by theory, in relation to the build-up of charge at the surface of the piezoelectric transducer (for embodiments employing a piezoelectric transducer).

The surface of 128° rotated Y cut LiNbO₃ forms strong dipoles and associated with this is an inherent negative charge. The surface charge present at the surface can be increased by the application of an external a.c. field applied to an interdigitated transducer. The sinusoidal excitation induces a mechanical wave. As the wave traverses the piezoelectric material it also induces a reciprocal process and charge flow or current in the material occurs. Where a liquid sample is located on the surface of the piezoelectric transducer, this excess charge can then be transferred to the liquid during nebulisation of the liquid.

Heron et al (2010) [mentioned above] referred to this and Ho et al (2011) [mentioned above] published experimental results and a possible mechanism for the charge transfer from the lithium niobate surface to the liquid. We note that although Ho et al (2011) nebulize from paper, the liquid is a continuous phase throughout the paper sample.

In relation to superstrates that are generally fabricated from dielectric or material which is not sufficiently conducting, there is the problem of how to transfer the native charge present on the transducer surface to the liquid sample if a non-conducting or low conducting barrier is placed in between charge source and liquid. A solution to this problem, as explained in relation to the preferred embodiments of the invention, is to introduce a conduction path to the liquid which is to be nebulized. This can be achieved by metalizing the bottom, whole or part, of the superstrate, the side(s) and then the top, to where the liquid sample is to be located and nebulized.

In an experimental investigation to further elucidate this mechanism, a superstrate with a suitable electrical connection was coupled to a LiNbO₃ transducer using either de-ionised water or KY jelly. A layer of DI water of 100 μm thick with the same area as the superstrate has a resistance of about 20 Kohm. A layer of KY jelly of the same thickness has a resistance of about 14 Kohm. The thickness of the coupling layer between the superstrate and the transducer was in practice less than 10 μm. Therefore the resistance between the superstrate and the transducer was about 1 Kohm.

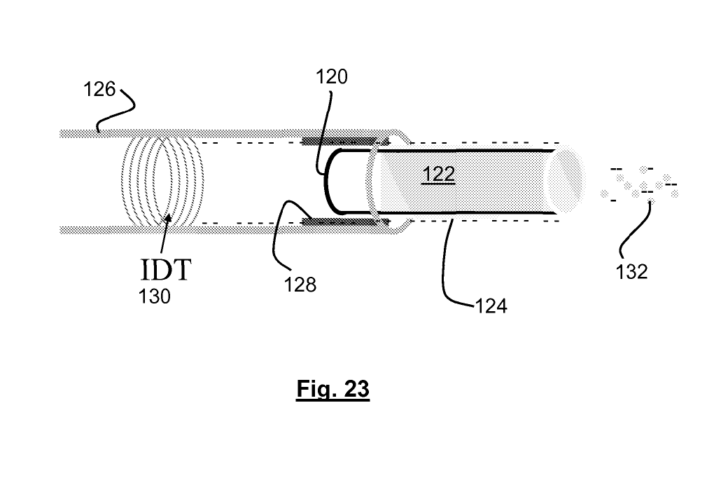

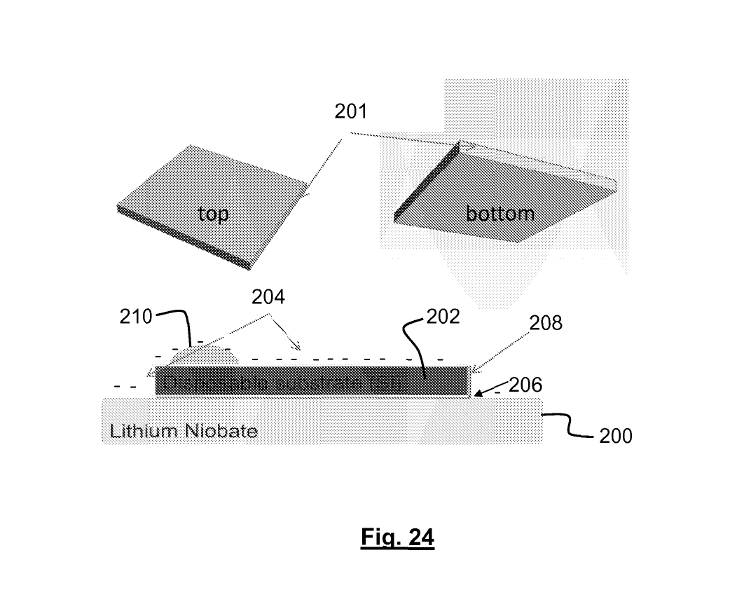

FIG. 24 (top left) shows a schematic perspective view of the top and two side surfaces of a silicon superstrate. FIG. 24 (top right) shows a schematic perspective view of the bottom and two side surfaces of the same silicon superstrate. The top and bottom are covered with gold films. One of the side surfaces has conductive paint 201 in order to establish an electrical connection between the top and bottom surfaces. The superstrate was an approximately 2 cm×1.5 cm piece of undoped <100> silicon with a thickness of 470 μm. The metallization comprised 100 nm of gold using a 10 nm titanium adhesion layer on the top and bottom with both faces electrically connected with the use of conductive paint.

FIG. 24 (bottom) shows a schematic cross sectional view of the superstrate 202 on the piezoelectric transducer 200. Coupling layer 206 is 5-10 μm thick. The excess negative charge 204 present on the lithium niobate surface is transferred to the top surface of the superstrate 202 by the presence of the conduction path 208. The negative charge is therefore supplied to the nanolitre or microliter droplet 210 of liquid sample on the superstrate.

Three experiments were carried out, differing in terms of the nature of the superstrate. In a first experiment, the superstrate was not present, the liquid sample being nebulized directly from the surface of the transducer. In a second experiment, the conducting superstrate shown in FIG. 24 was used. In a third experiment, a non-conducting silicon substrate was used, identical to the substrate shown in FIG. 24 except that the conductive layers were absent.

The presence of charge on the nebulised droplets was detected with the aid of an electrometer (Keithely 617) which was computer controlled. The measurements were conducted in a Faraday cage in order to minimise background rf interference. However, due to the small signals that were to be recorded there was some variation in the measurements. The electrometer has very high input impedance which allows it to measure the surface charge present on the metal plate relative to electrical ground.

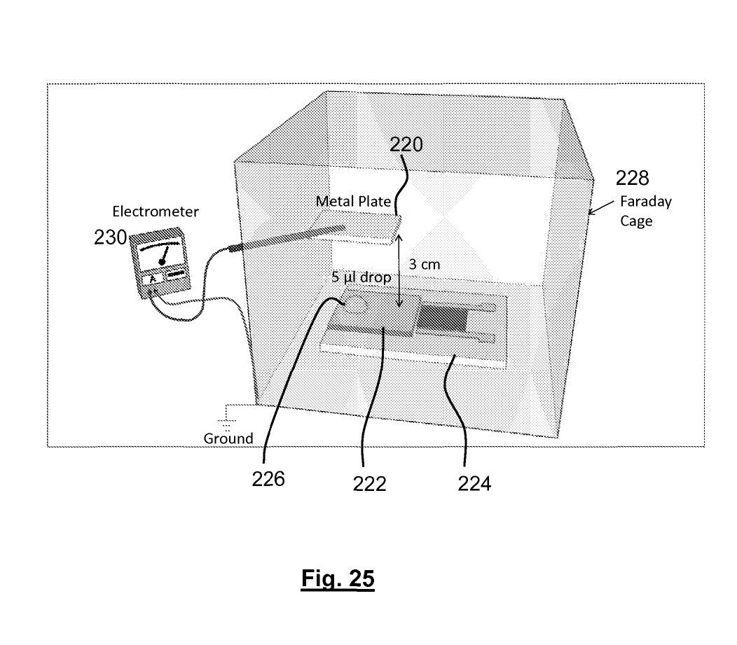

FIG. 25 shows the experimental set up for determining the effect of a conductive superstrate on the charging of the nebulized droplets. Metal plate 220 (3 cm×5 cm) was held 3 cm above the superstrate 222. Superstrate 222 is located on piezoelectric transducer 224. Liquid sample droplet 226 is located on the upper surface of superstrate 222. The SAWs were generated by driving the transducer 224 at 12 MHz. A Faraday cage 228 enclosed the apparatus. Electrometer 230 was connected between metal plate 220 and ground.

The relatively large distance between the drop 226 and collector plate 220 was chosen to avoid any jetting phenomenon providing false positive results. Approximately every ten seconds a 5 μL drop of DI water was nebulised, in each of the three experiments.

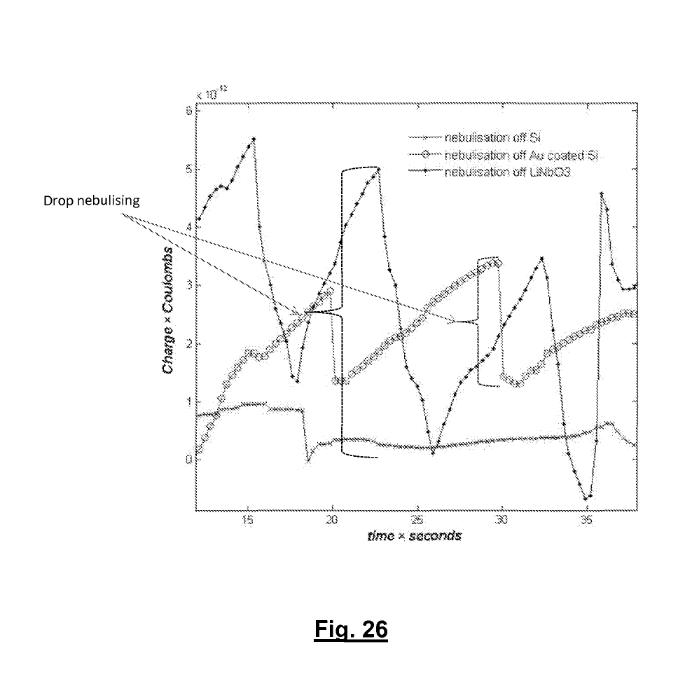

FIG. 26 shows three overlaid graphs, each representing the charge measured at plate 220 with time.

Nebulization directly off LiNbO₃ is shown by dot datapoints. Nebulization off gold coated silicon is shown by circle datapoints. Nebulization off plain silicon is shown by cross datapoints.

The procedure was to repeatedly nebulise 5 μL drops on a ten second cycle in order to discriminate against spurious artefacts. It is evident from FIG. 26 that the LiNbO₃ trace shows a greater effect than the gold coated silicon while the plain silicon shows no cyclic behaviour on an approximately 10 second period.

The results show that there is a definite charge excess on the aerosols produced on LiNbO₃ and this excess charge is also present on the conductive silicon superstrate, although the magnitude of the excess is approximately half that on the LiNbO₃ transducer surface. It is not apparent from the non-conductive superstrate of any significant charge transference to the liquid drops and hence the aerosols produced on that superstrate. The difference in magnitude of the LiNbO₃ and the conductive superstrate can be attributed to the electrical impedance of the coupling medium. Use of a coupling medium with lower resistance would allow more charge to be supplied to the nebulising liquid.

The results show that it is possible to transfer a significant excess charge, in this case a negative charge, to the sample liquid as it nebulises from Y-cut LiNbO₃. Similarly, by providing a conduction path from the LiNbO₃ surface to the superstrate top surface, the nebulizing droplets are provided with a suitable charge to allow them to be manipulated for detection via a mass spectrometer.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. A device for generating a nebulized sample for detection of an analyte, the device including a SAW transducer and a superstrate, the superstrate having a first surface for coupling with the SAW transducer and a second surface for receiving a fluid sample incorporating the analyte and for nebulizing the fluid sample from the second surface, wherein the superstrate is provided with an electrical connection extending from the second surface of the superstrate to provide a conducting path from a charge source to the second surface of the superstrate.

2. The device according to claim 1 wherein the charge source is the surface of the SAW transducer.

3. The device according to claim 1 wherein the charge source is a terminal of a power source held at a required electrical potential.

4. The device according to claim 1 wherein the electrical connection from the second surface to the charge source is provided at least in part by a solid electrical connection.

5. The device according to claim 1 wherein the entire superstrate is formed of an electrically conductive material.

6. The device according to claim 1 wherein coupling of the SAWs between the transducer and the superstrate is achieved using a coupling medium, wherein the coupling medium is electrically conductive.

7. The device according to claim 1 wherein the superstrate is formed of a material which is impervious to the fluid sample.

8. The device according to claim 1 wherein the superstrate is disposable.

9. The device according to claim 1 wherein the second surface of the superstrate has a substantially planar form.

10. The device according to claim 1 wherein the second surface of the superstrate has a substantially curved form.

11. The device according to claim 10 wherein the superstrate has a tubular configuration and is located at least partly within or around the SAW transducer.

12. The device according to claim 1 wherein the transducer is a piezoelectric transducer.

13. The device according to claim 1 wherein the superstrate includes at least one SAW scattering element operable to affect the transmission, distribution or behaviour of SAWs at the superstrate surface.

14. A method for analysis of an analyte, including the steps of:
providing a fluid sample incorporating the analyte;
providing a SAW transducer;
providing a superstrate having a first surface and a second surface;
providing an analytical instrument having an inlet port for receiving analyte;
coupling the first surface of the superstrate to the SAW transducer so as to transmit SAWs from the SAW transducer to the second surface of the superstrate;
locating the fluid sample on the second surface of the superstrate; and
operating the SAW transducer to nebulize the sample from the second surface of the superstrate to cause at least some of the nebulized sample to enter the inlet port of the analytical instrument whilst providing a conducting path from the second surface of the superstrate to a charge source.

15. The method according to claim 14 wherein other manipulation of the sample is carried out, prior to nebulization, said other manipulation including one or more of: movement of the sample; splitting of the sample; combining two or more samples; heating of the sample; concentration of species in the sample; mixing of the sample; sorting fluid samples; sorting particles or cells within fluid samples.

16. The method according to claim 14 further including the steps of disposing of the superstrate and repeating the method using the same transducer and a fresh superstrate.

17. A system for analysis of an analyte, the system having:
a SAW transducer;
a superstrate; and
an analytical instrument having an inlet port for receiving analyte,
wherein the superstrate has a first surface for coupling with the SAW transducer and a second surface for receiving a fluid sample incorporating the analyte, and wherein the superstrate is provided with an electrical connection extending from the second surface of the superstrate to provide a conducting path from a charge source to the second surface of the superstrate, the SAW transducer being operable to nebulize the sample from the second surface of the superstrate to cause at least some of the nebulized sample to enter the inlet port of the analytical instrument for analysis.

18. The system according to claim 17 wherein the analytical instrument is a mass spectrometer.
